(19) United States
(12) Patent Application Publication
(10) Pub. No.: US 2024/0172273 A1
(43) Pub. Date: May 23, 2024

(54) Method For Preamble Puncturing Negotiation In Wireless Communications

(71) Applicant: MediaTek Inc., Hsinchu City (TW)

(72) Inventors: Cheng-Yi Chang, Hsinchu City (TW); Kun-Sheng Huang, Hsinchu City (TW); Yi-Hsuan Chung, Hsinchu City (TW); Chung-Kai Hsu, Hsinchu City (TW); Chia-Hsiang Chang, Hsinchu City (TW); Kai Ying Lu, San Jose, CA (US)

(21) Appl. No.: 18/509,360

(22) Filed: Nov. 15, 2023

Related U.S. Application Data
(60) Provisional application No. 63/384,113, filed on Nov. 17, 2022.

(51) Int. Cl. H04W 74/00; H04W 74/0816

(52) U.S. Cl. CPC H04W 74/006; H04W 74/0816

(57) ABSTRACT

Examples pertaining to preamble puncturing negotiation in wireless communications are described. A station (STA) may receive a control frame, and, in response, apply the MRU pattern for one or more transmissions or receptions in a transmission opportunity (TXOP). In the control frame, either a plurality of first reserved bits in a SERVICE field or a plurality of bits in a User Info field are set to indicate a multiple resource unit (MRU) pattern regarding preamble puncturing.

### CROSS REFERENCE TO RELATED PATENT APPLICATION(S)

The present disclosure is part of a non-provisional application claiming the priority benefit of U.S. Patent Application Nos. 63/384,113, 63/487,892, 63/487,893 and 63/487,896, filed 17 Nov. 2022, 2 Mar. 2023, 2 Mar. 2023 and 2 Mar. 2023, respectively, the contents of which herein being incorporated by reference in their entirety.

### TECHNICAL FIELD

The present disclosure is generally related to mobile communications and, more particularly, to preamble puncturing negotiation in wireless communications.

### BACKGROUND

Unless otherwise indicated herein, approaches described in this section are not prior art to the claims listed below and are not admitted as prior art by inclusion in this section.

In a wireless system, such as a wireless local area network (WLAN) under the Institute of Electrical and Electronics Engineers (IEEE) 802.11 specification(s), a multi-resource unit (MRU), as an aggregate of multiple resource units (RUs), with different tone combinations can be used to support dynamic preamble puncturing in order to improve spectral efficiency in a wide-bandwidth system. In a non-orthogonal frequency-divisional multiple access (non-OFDMA) extremely-high-throughput (EHT) physical-layer protocol data unit (PPDU) with a specific bandwidth, one or more MRU patterns are allowed to support static/dynamic preamble puncturing. For example, in a non-OFDMA 80 mega-hertz (MHz) EHT PPDU, 484+242-tone MRUs are allowed and supported, with 4 options. Additionally, in a non-OFDMA 160 MHZ EHT PPDU, 996+484-tone MRUs as well as 996+484+242-tone MRUs are allowed and supported, with 4 MRU pattern options and 8 MRU pattern options, respectively. Moreover, in a non-OFDMA 320 MHz EHT PPDU, 2×996+484-tone MRUs, 3×996-tone MRUs, and 3×996+484-tone MRUs are allowed and supported, with 12 options, 4 options and 8 options, respectively.

Based on a transmission opportunity (TXOP) initiator's bandwidth and preamble puncturing information (e.g., MRU pattern(s)), a TXOP responder can negotiate bandwidth and MRU pattern with the TXOP initiator. With the negotiated information, the TXOP initiator may be able to assign a proper MRU pattern for communications with the TXOP responder. However, it is observed that the signal interference in real environments often changes rapidly, especially in overlapping basic service set (OBSS) scenarios. Therefore, there is a need for a solution of negotiating preamble puncturing information dynamically whenever needed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to preamble puncturing negotiation in wireless communications.

In one aspect, a method may involve a station (STA) receiving a control frame, wherein either a plurality of first reserved bits in a SERVICE field or a plurality of bits in a User Info field of the control frame are set to indicate an MRU pattern regarding preamble puncturing. The method may also involve the STA applying the MRU pattern for one or more transmissions or receptions in a TXOP.

In another aspect, a method may involve an STA detecting preambles in a plurality of narrow bandwidths of a wide bandwidth. The method may also involve the STA determining an MRU pattern regarding preamble puncturing according to the detected preambles. The method may further involve the STA applying the MRU pattern for one or more transmissions or receptions in a TXOP.

In another aspect, a method may involve an STA transmitting a first bandwidth query report (BQR), wherein an Available Channel Bitmap subfield of the first BQR is set to indicate a first MRU pattern regarding preamble puncturing. The method may also involve the STA performing a first transmission or reception according to the first MRU pattern.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IOT) and Narrow Band Internet of Things (NB-IOT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a network environment in which various solutions and schemes in accordance with the present disclosure may be implemented.

FIG. 2 is a diagram depicting an example scenario of preamble puncturing negotiations in wireless communications under schemes in accordance with implementations of the present disclosure.

FIG. 3 is a diagram depicting an example scenario of negotiation signaling for bandwidth and MRU pattern indication under a first proposed scheme in accordance with implementations of the present disclosure.

FIGS. 4A and 4B show a diagram depicting an example scenario of an encoding table for using reserved bits of the SERVICE field for MRU pattern indication under the first proposed scheme in accordance with implementations of the present disclosure.

FIG. 5 is a diagram depicting an example scenario of the User Info field formats of a control frame under a second proposed scheme in accordance with implementations of the present disclosure.

FIGS. 6A and 6C show a diagram depicting an example scenario of an encoding table for using PS160 subfield and RU Allocation subfield for MRU pattern indication under the second proposed scheme in accordance with implementations of the present disclosure.

FIG. 7 is a diagram depicting an example scenario of implicit preamble puncturing negotiation under a third proposed scheme in accordance with an implementation of the present disclosure.

FIG. 8 is a diagram depicting an example scenario of implicit preamble puncturing negotiation under the third proposed scheme in accordance with another implementation of the present disclosure.

FIG. 9 is a diagram depicting an example scenario of dynamic preamble puncturing negotiation with different design options under a fourth proposed scheme in accordance with implementations of the present disclosure.

FIG. 10 is a diagram depicting an example scenario of MRU pattern assignment under the fourth proposed scheme in accordance with an implementation of the present disclosure.

FIG. 11 is a diagram depicting an example communication system in accordance with an implementation of the present disclosure.

FIG. 12 is a flowchart of an example process in accordance with an implementation of the present disclosure.

FIG. 13 is a flowchart of another example process in accordance with an implementation of the present disclosure.

FIG. 14 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to preamble puncturing negotiation in wireless communications. According to the present disclosure, a number of possible solutions may be implemented separately or jointly. That is, although these possible solutions may be described below separately, two or more of these possible solutions may be implemented in one combination or another.

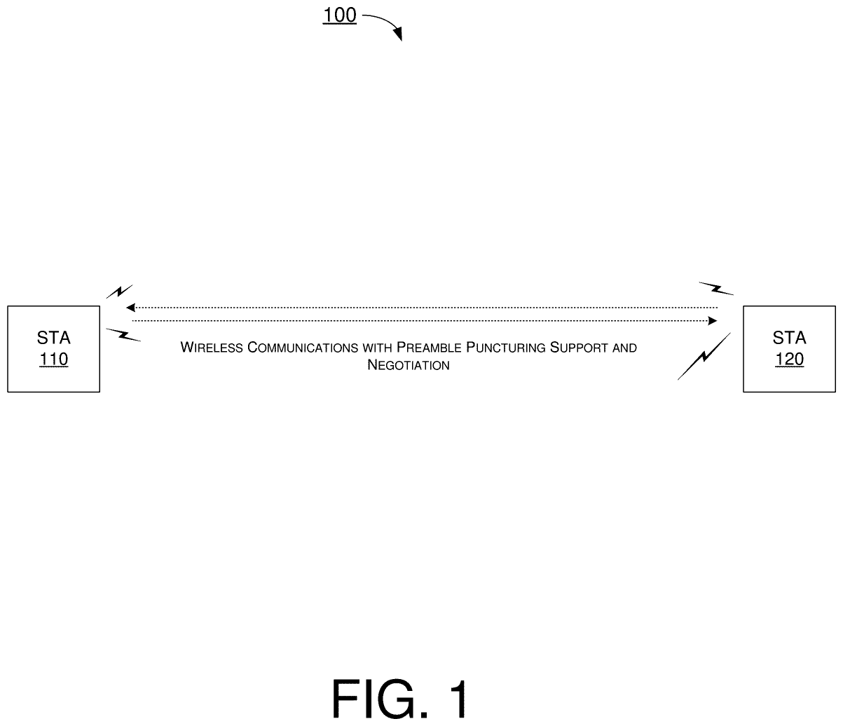

FIG. 1 illustrates an example scenario 100 of a network environment in which various solutions and schemes in accordance with the present disclosure may be implemented. Scenario 100 involve a network environment including at least a STA 110 and a STA 120, wherein STA 110 and STA 120 wirelessly communicate with each other in accordance with one or more Institute of Electrical and Electronics Engineers (IEEE) 802.11 standards (e.g., IEEE 802.11be and future-developed standards) such as Wi-Fi 7. Each of STA 110 and STA 120 may function as an access point (AP) STA, a non-AP STA, or a peer-to-peer (P2P) STA. Each of STA 110 and STA 120 may be configured to communicate with each other by utilizing the various proposed schemes described herein pertaining to preamble puncturing negotiation in wireless communications.

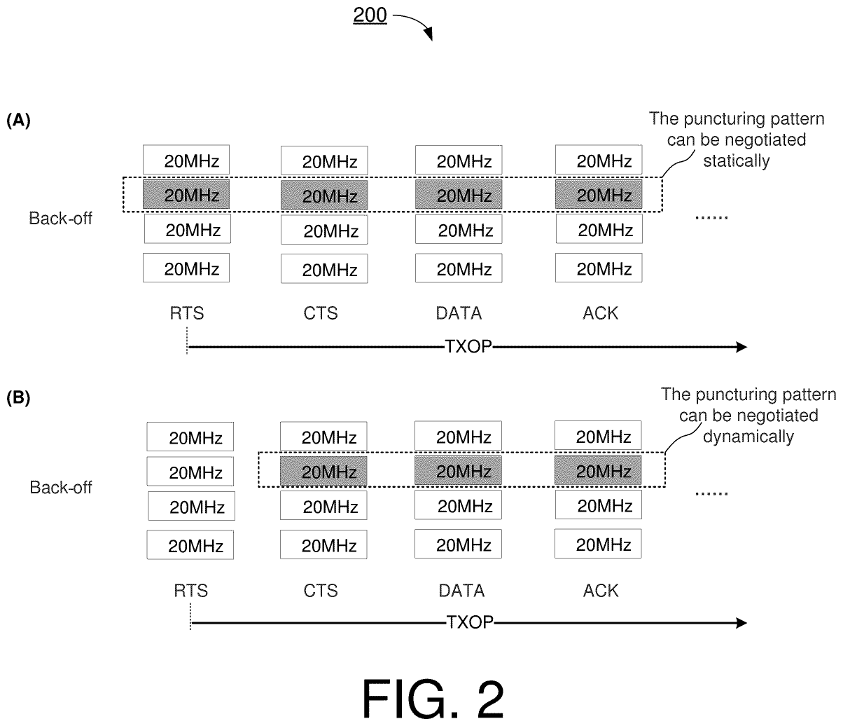

FIG. 2 illustrates an example scenario 200 of preamble puncturing negotiations in wireless communications under schemes in accordance with implementations of the present disclosure. Scenario 200 involves a series of transmission (TX) and reception (RX) operations between two STAs within a TXOP. Specifically, within a TXOP, a STA functioned as a TXOP initiator may transmit a request-to-send (RTS) to another STA functioned as a TXOP responder. Upon reception of the RTS, the TXOP responder may transmit a clear-to-send (CTS) to the TXOP initiator. Next, the TXOP initiator may start data transmission, and the TXOP responder may acknowledge safe receipt of the data. More specifically, the transmissions/receptions within the TXOP may be performed with preamble puncturing (e.g., puncturing the third 20 MHz channel), and the MRU pattern regarding preamble puncturing may be negotiated statically or dynamically. Part (A) of FIG. 2 shows the preamble puncturing negotiation in which the negotiated MRU pattern regarding preamble puncturing is static within the TXOP, while Part (B) of FIG. 2 shows the preamble puncturing negotiation in which the MRU pattern regarding preamble puncturing can be negotiated dynamically within the TXOP.

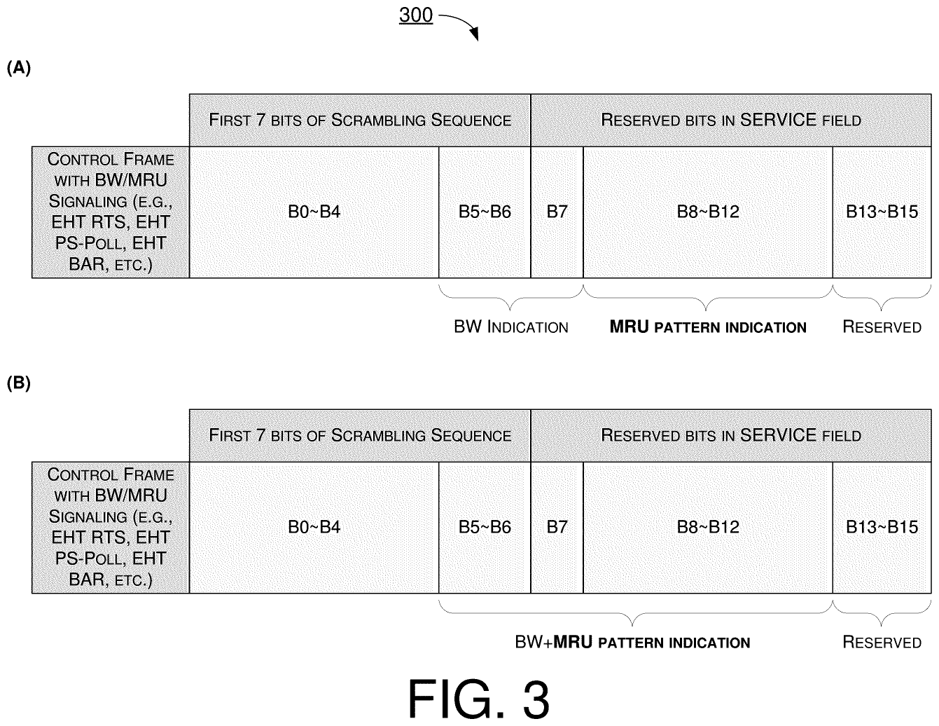

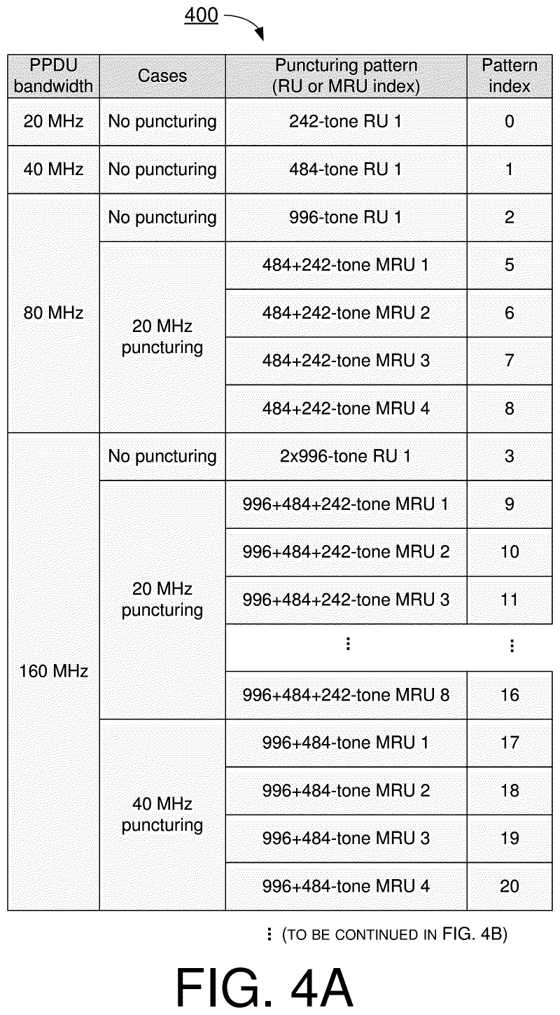

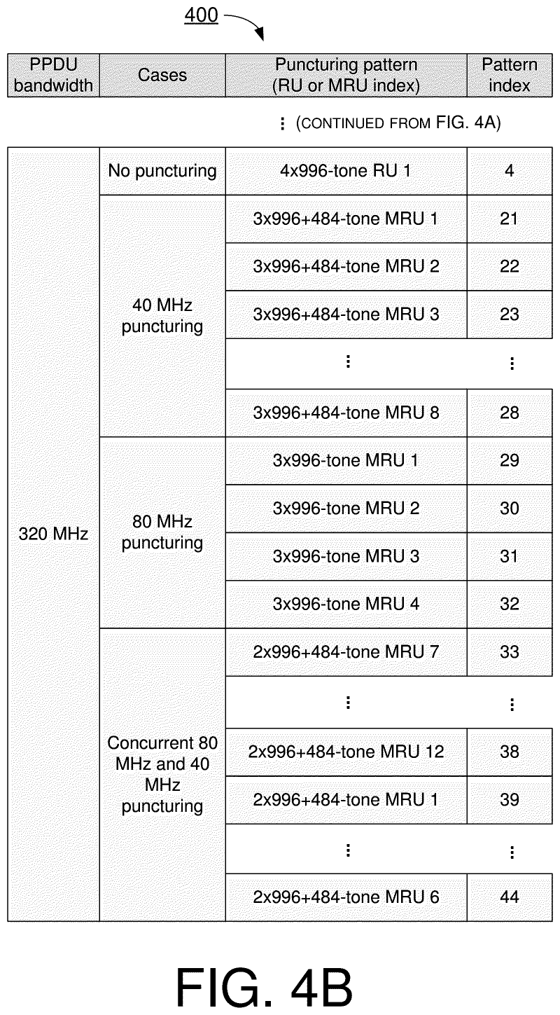

Under a first proposed scheme in accordance with the present disclosure with respect to preamble puncturing negotiation, a plurality of reserved bits in the SERVICE field of a control frame may be used to indicate the MRU pattern regarding preamble puncturing. FIG. 3 illustrates an example scenario 300 of negotiation signaling for bandwidth and MRU pattern indication under this proposed scheme. Scenario 300 involves two different design options in which the negotiation signaling for MRU pattern indication is implemented by a non-high-throughput (non-HT) (e.g., EHT) control frame (e.g., RTS, power save poll (PS-Poll), block acknowledgement request (BAR), and the like). Part (A) of FIG. 3 shows the first design option where only several reserved bits (e.g., B8˜B12) in the SERVICE field are used to indicate MRU pattern. Part (B) of FIG. 3 shows the second design option where part of the first 7 bits of the scrambling sequence (e.g., bits B5˜B6) and part of the reserved bits in the SERVICE field (e.g., bits B7˜B12) may be used jointly to indicate both bandwidth and MRU pattern. FIGS. 4A and 4B illustrate an example scenario 400 of an encoding table for using reserved bits of the SERVICE field for MRU pattern indication under this proposed scheme.

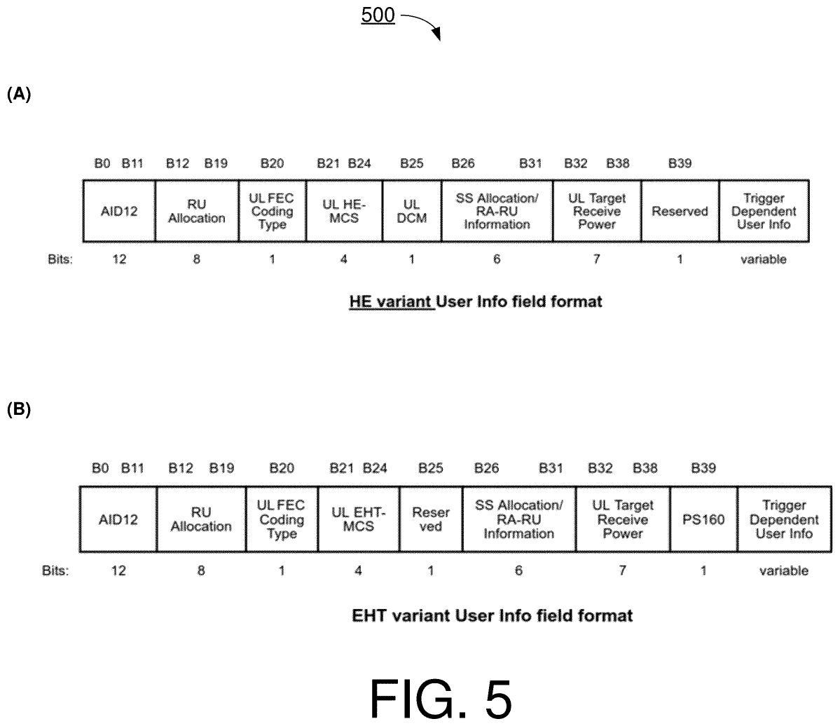

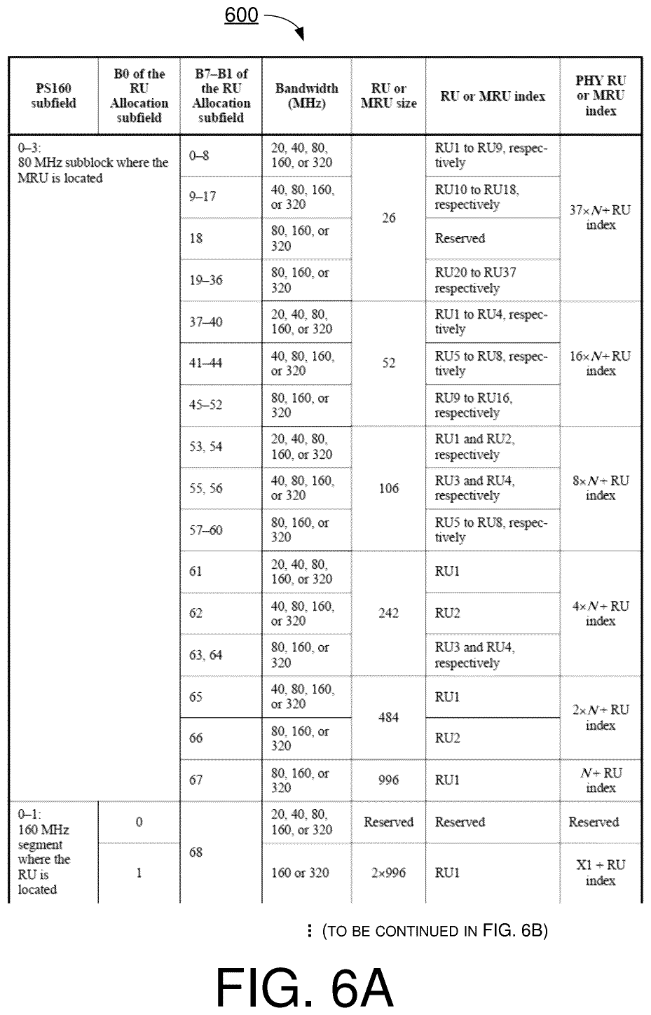

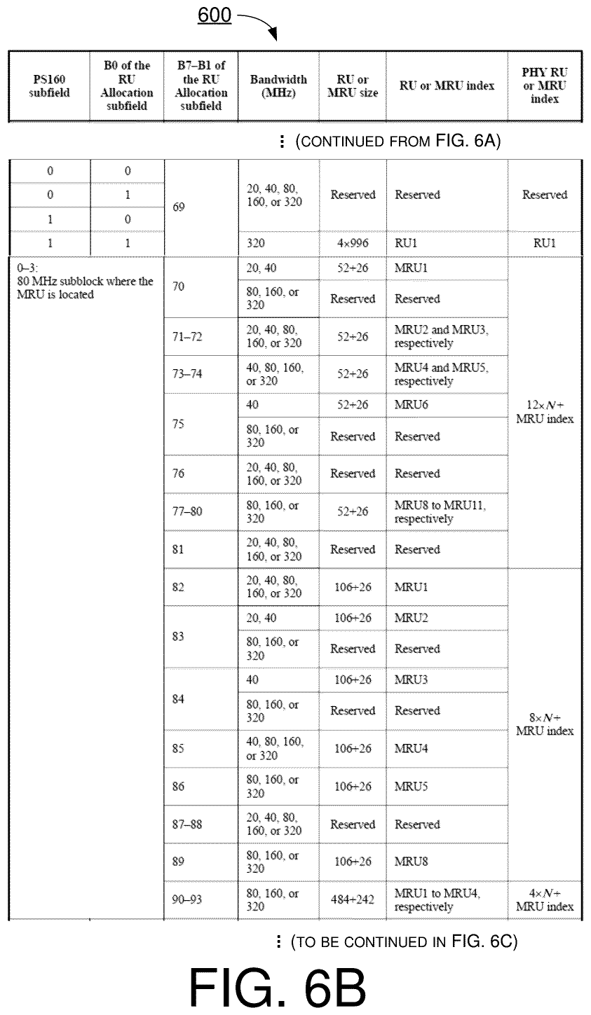

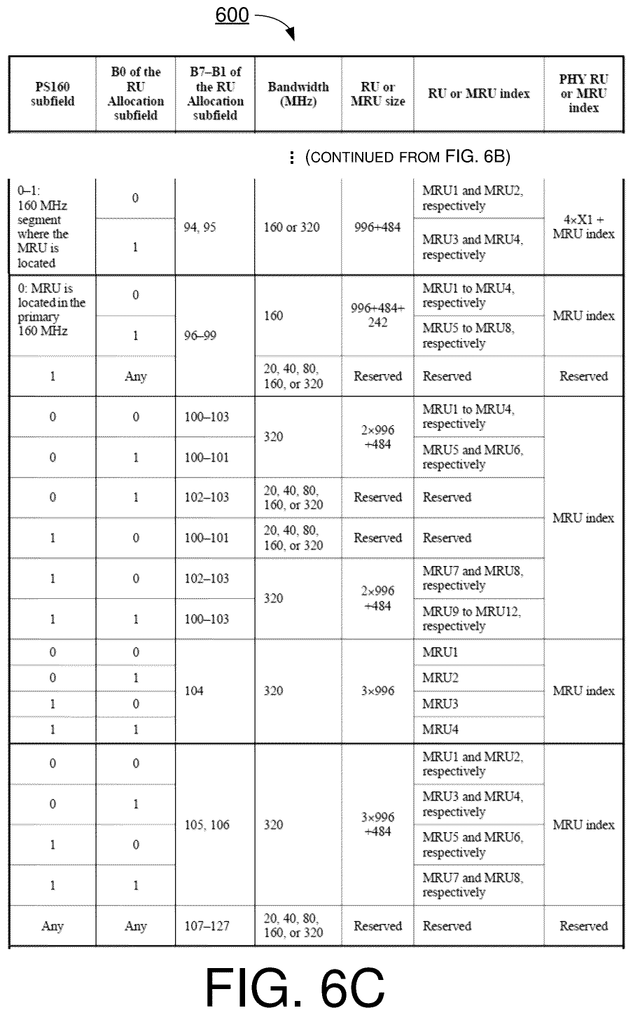

Under a second proposed scheme in accordance with the present disclosure with respect to preamble puncturing negotiation, a plurality of bits in the User Info of a control frame may be used to indicate MRU pattern regarding preamble puncturing. Specifically, the plurality of bits in the User Info field of the control frame includes a PS160 subfield and a plurality of bits (e.g., B0˜B7) of a resource unit (RU) Allocation subfield. More specifically, the PS160 subfield and B0 of the RU Allocation subfield should not be ignored (i.e., should be considered) for MRU pattern indication. FIG. 5 illustrates an example scenario 500 of the User Info field formats of a control frame under this proposed scheme. Scenario 500 involves two different User Info field formats in which the negotiation signaling for MRU pattern indication is implemented by a non-HT control frame (e.g., RTS, PS-Poll, BAR, and the like). Part (A) of FIG. 5 shows the High Efficiency (HE) variant User Info field format, while Part (B) of FIG. 5 shows the EHT variant User Info field format. FIGS. 6A to 6C illustrate an example scenario 600 of an encoding table for using PS160 subfield and RU Allocation subfield for MRU pattern indication under this proposed scheme.

In some implementations, B0 of the RU Allocation subfield is set to 0 to indicate primary 20 MHz channel, primary 40 MHz channel and primary 80 MHz channel. For 160 MHz and 80+80 MHz indication, B0 of the RU Allocation subfield is set to 1. A non-AP STA ignores B0 for 160 MHz and 80+80 MHz indication.

In some implementations, B0 of the RU Allocation subfield is set to 0 to indicate primary 20 MHz channel, primary 40 MHz channel and primary 80 MHz channel. For primary 160 MHZ, 80+80 MHZ, and 320 MHz indication, B0 of the RU Allocation subfield is set to 1. A non-AP HE STA ignores B0 for primary 160 MHz and 80+80 MHZ (HE only) indication. A non-AP EHT STA checks B0 for primary 160 MHz and 320 MHz indication if the non-AP EHT STA is addressed by an EHT variant User Info field. In an EHT variant User Info field, the PS160 subfield is set to 1 to indicate 320 MHz channel and set to 0 to indicate primary 20 MHz channel, primary 40 MHz channel, primary 80 MHz channel, and primary 160 MHz channel.

In some implementations, a capability field in the Medium Access Control (MAC) capability element (e.g., of a management frame) may be set to indicate support of multiple user-request-to-send (MU-RTS) MRU puncturing.

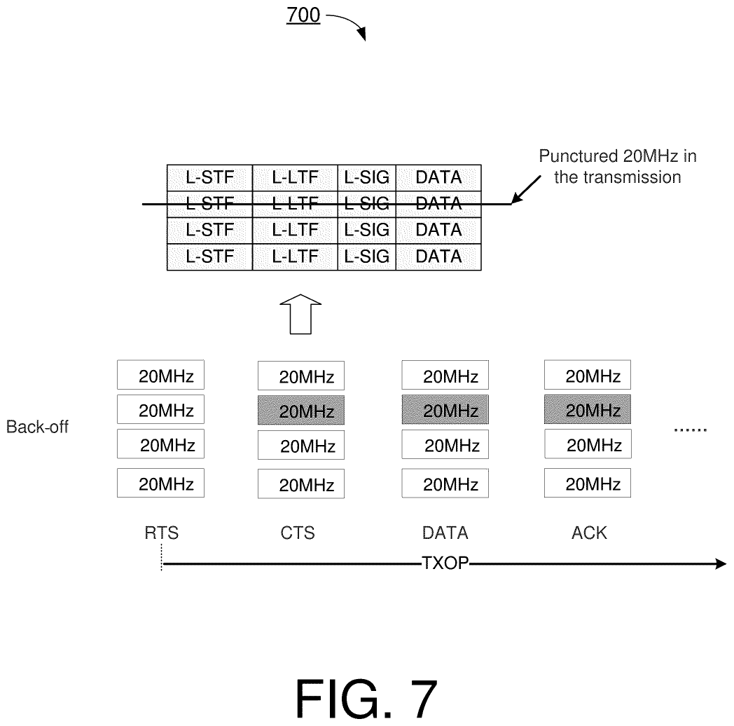

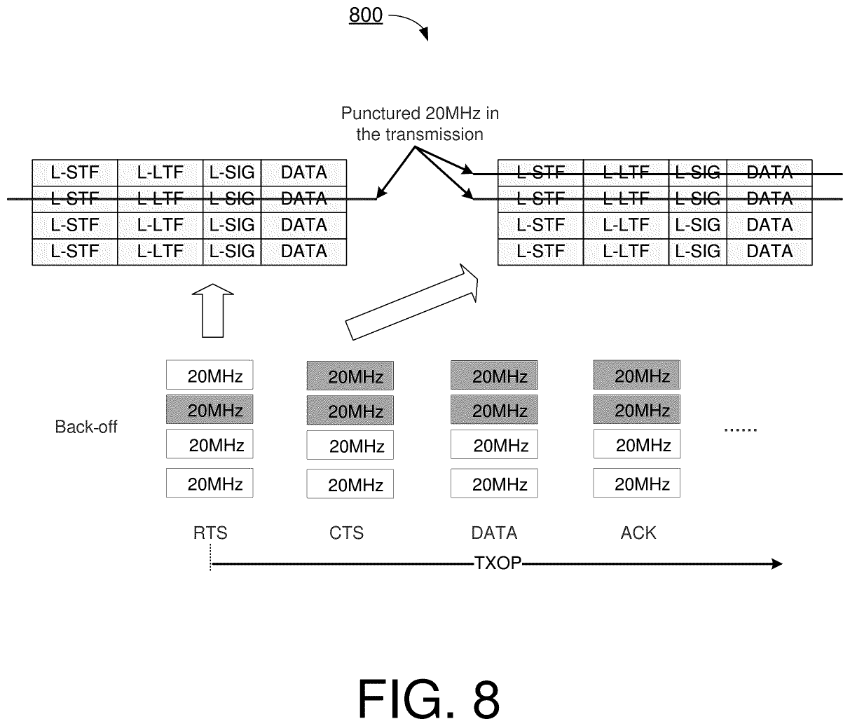

Under a third proposed scheme in accordance with the present disclosure with respect to preamble puncturing negotiation, STAs may implicitly negotiate MRU pattern according to detected preamble fields (e.g., legacy short training fields (L-STFs), legacy long training field (L-LTFs), or legacy signal (L-SIG) fields) in a plurality of narrow bandwidths (e.g., 20 MHz channel bandwidth (CBW)) of a wide bandwidth (e.g., 80 MHz channel). Specifically, the MRU pattern indication may be determined by cyclic redundancy check (CRC) checks on the L-STFs, the L-LTFs, or the L-SIG fields of the detected preambles (e.g., a failed CRC check indicates that the CBW where the preamble is detected is punctured). Alternatively, the MRU pattern indication may be determined by the correlation of the L-STFs, the L-LTFs, or the L-SIG fields of the detected preambles (e.g., low correlation of L-STF/L-LTF/L-SIG field in a first CBW with L-STFs/L-LTFs/L-SIG fields in other CBWs indicates that the first CBW is punctured). FIG. 7 illustrates an example scenario 700 of implicit preamble puncturing negotiation under this proposed scheme in accordance with an implementation of the present disclosure. Scenario 700 involves a TXOP initiator transmitting an RTS in a wide bandwidth (e.g., 80 MHz channel) without preamble puncturing, and a TXOP responder transmitting a CTS with preamble puncturing according to an MRU pattern in which a narrow bandwidth (e.g., the third 20 MHz channel) is punctured. Based on the preambles detected in the narrower bandwidths, the TXOP initiator may determine the MRU pattern that indicates puncturing in the third 20 MHz channel, and the MRU pattern may be applied for subsequent transmissions and receptions in the TXOP. FIG. 8 illustrates an example scenario 800 of implicit preamble puncturing negotiation under this proposed scheme in accordance with another implementation of the present disclosure. Scenario 800 involves a TXOP initiator transmitting an RTS in a wide bandwidth (e.g., 80 MHz channel) with preamble puncturing according to an MRU pattern in which the third 20 MHz channel (referred to herein as CBW3) is punctured. Based on the preambles detected in the narrower bandwidths, the TXOP responder may determine the MRU pattern that indicates puncturing in CBW1 and transmit a CTS with preamble puncturing according to another MRU pattern in which the fourth 20 MHz channel (referred to herein as CBW4) along with CBW3 are punctured. After that, the TXOP initiator may determine the updated MRU pattern that indicates puncturing in CBW3 and CBW4, and the updated MRU pattern may be applied for subsequent transmissions and receptions in the TXOP.

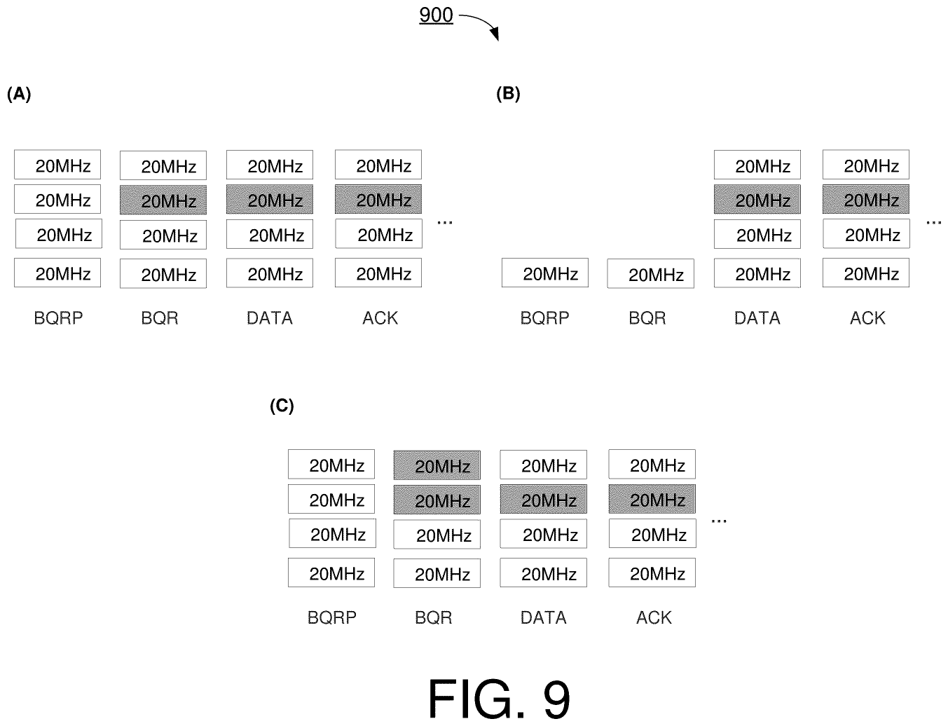

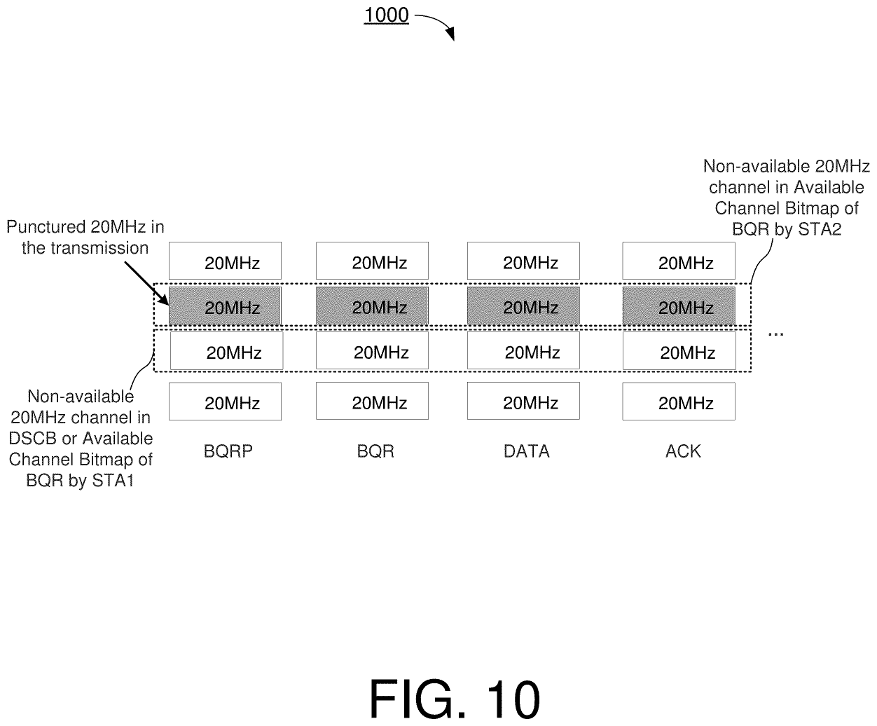

Under a fourth proposed scheme in accordance with the present disclosure with respect to preamble puncturing negotiation, the Available Channel Bitmap subfield (e.g., B0˜B7) of a BQR may be used to indicate MRU pattern regarding preamble puncturing. In order to do this, the capability field in the MAC capability element (e.g., of a management frame) should be able to indicate support of non-AP preamble puncturing by BQR. Through the negotiation by BQR(s), the preamble puncturing may be static or dynamic within a TXOP. For static preamble puncturing, the BQR initiator may indicate the static MRU pattern in the BQR Control subfield of an A-control subfield or multiple BQR Control subfields, and the BQR responder may solicit an immediate response (e.g., an acknowledgement of the BQR). If the BQR initiator wishes to change the MRU pattern, it can make the change only after the TXOP in which it received the acknowledgment of the BQR. For dynamic preamble puncturing, a TXOP initiator may transmit a bandwidth query report poll (BQRP), and a TXOP responder may reply with a BQR in which an Available Channel Bitmap subfield is used to indicate the latest MRU pattern. The content of the BQR may include clear channel assessment (CCA) results sensed in a short interframe space (SIFS) between the reception of the BQRP and the transmission of the BQR, and the CCA results may be used as indication of the MRU pattern. FIG. 9 illustrates an example scenario 900 of dynamic preamble puncturing negotiation with different design options under this proposed scheme. Part (A) of FIG. 9 shows the first design option in which the BQRP is transmitted in a wide bandwidth (e.g., 80 MHZ channel) without preamble puncturing and the BQR is transmitted according to an MRU pattern with preamble puncturing in the third 20 MHz channel. Part (B) of FIG. 9 shows the second design option in which the BQRP is transmitted only in one narrow bandwidth (e.g., the first 20 MHz channel) and the BQR is transmitted only in the same narrow bandwidth. Part (C) of FIG. 9 shows the third design option in which the BQRP is transmitted in a wide bandwidth (e.g., 80 MHz channel) without preamble puncturing and the BQR is transmitted according to an MRU pattern (e.g., with preamble puncturing in the third 20 MHz channel) and the channel status information (e.g., indicating that the fourth 20 MHz channel is temporarily unavailable). Later, when the temporary unavailability is resolved, subsequent transmission(s) and reception(s) are performed according to the latest negotiated MRU pattern. FIG. 10 illustrates an example scenario 1000 of MRU pattern assignment under this proposed scheme in accordance with an implementation of the present disclosure. Scenario 1000 involves a conflict resolution to weigh between different MRU patterns of two STAs. Specifically, when there is a conflict between the Available Channel Bitmap subfield (e.g., indicating a first MRU pattern) of a first BQR sent by an STA (herein interchangeably denoted as “STA1”) and the Available Channel Bitmap subfield (e.g., indicating a second MRU pattern) of a second BQR received from a peer STA (herein interchangeably denoted as “STA2”), STA1 may assign/apply only the second MRU pattern (i.e., ignore the first MRU pattern) for subsequent transmissions and receptions. Alternatively, when there is a conflict between the disabled sub-channel bitmap (DSCB) field (e.g., indicating a first MRU pattern) of a beacon frame sent by STA1 and the Available Channel Bitmap subfield (e.g., indicating a second MRU pattern) of the second BQR received from STA2, STA1 may assign/apply only the second MRU pattern (i.e., ignore the first MRU pattern) for subsequent transmissions and receptions.

### Illustrative Implementations

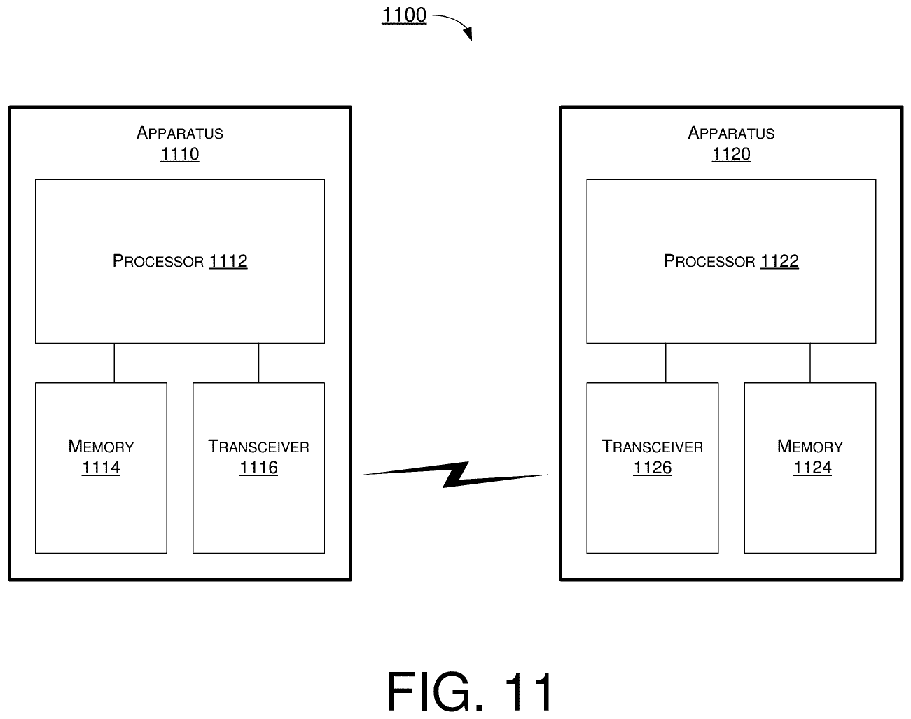

FIG. 11 illustrates an example communication system 1100 having an example apparatus 1110 and an example apparatus 1120 in accordance with an implementation of the present disclosure. Each of apparatus 1110 and apparatus 1120 may perform various functions to implement schemes, techniques, processes and methods described herein pertaining to preamble puncturing negotiation in wireless communications, including scenarios/schemes described above as well as processes 1200, 1300, and 1400 described below.

Each of apparatus 1110 and apparatus 1120 may be a part of an electronic apparatus, which may be a non-AP STA, a P2P STA, or an AP STA, such as a portable or mobile apparatus, a wearable apparatus, a wireless communication apparatus or a computing apparatus. When implemented in a non-AP STA or a P2P STA, each of apparatus 1110 and apparatus 1120 may be implemented in a smartphone, a smart watch, a personal digital assistant, a digital camera, or a computing equipment such as a tablet computer, a laptop computer or a notebook computer. Each of apparatus 1110 and apparatus 1120 may also be a part of a machine type apparatus, which may be an IoT apparatus such as an immobile or a stationary apparatus, a home apparatus, a wire communication apparatus or a computing apparatus. For instance, each of apparatus 1110 and apparatus 1120 may be implemented in a smart thermostat, a smart fridge, a smart door lock, a wireless speaker or a home control center. When implemented in or as a network apparatus, apparatus 1110 and/or apparatus 1120 may be implemented in a network node, such as an AP in a WLAN.

In some implementations, each of apparatus 1110 and apparatus 1120 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1110 and apparatus 1120 may be implemented in or as a non-AP STA, a P2P STA, or an AP STA. Each of apparatus 1110 and apparatus 1120 may include at least some of those components shown in FIG. 11 such as a processor 1112 and a processor 1122, respectively, for example. Each of apparatus 1110 and apparatus 1120 may further include one or more other components not pertinent to the proposed scheme of the present disclosure (e.g., internal power supply, display device and/or user interface device), and, thus, such component(s) of apparatus 1110 and apparatus 1120 are neither shown in FIG. 11 nor described below in the interest of simplicity and brevity.

In one aspect, each of processor 1112 and processor 1122 may be implemented in the form of one or more single-core processors, one or more multi-core processors, one or more RISC processors or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including those pertaining to preamble puncturing negotiation in wireless communications in accordance with various implementations of the present disclosure.

In some implementations, apparatus 1110 may also include a transceiver 1116 coupled to processor 1112. Transceiver 1116 may include a transmitter capable of wirelessly transmitting and a receiver capable of wirelessly receiving data. In some implementations, transceiver 1116 may be equipped with a plurality of antenna ports (not shown). That is, transceiver 1116 may be equipped with multiple transmit antennas and multiple receive antennas for multiple-input multiple-output (MIMO) wireless communications. In some implementations, apparatus 1120 may also include a transceiver 1126 coupled to processor 1122. Transceiver 1126 may include a transmitter capable of wirelessly transmitting and a receiver capable of wirelessly receiving data. In some implementations, transceiver 1126 may be equipped with a plurality of antenna ports (not shown). That is, transceiver 1126 may be equipped with multiple transmit antennas and multiple receive antennas for MIMO wireless communications.

In some implementations, apparatus 1110 may further include a memory 1114 coupled to processor 1112 and capable of being accessed by processor 1112 and storing data therein. In some implementations, apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of capabilities of apparatus 1110, implemented in or as STA 110, and apparatus 1120, implemented in or as STA 120, is provided below. It is noteworthy that, although the example implementations described below are provided in the context of WLAN, the same may be implemented in other types of networks.

According to some schemes of the present disclosure, processor 1112 of apparatus 1110 may receive, via transceiver 1116, a control frame (e.g., from apparatus 1120), wherein either a plurality of first reserved bits in a SERVICE field or a plurality of bits in a User Info field of the control frame are set to indicate an MRU pattern regarding preamble puncturing. Then, processor 1112 may apply the MRU pattern for one or more transmissions or receptions in a TXOP.

In some implementations, one or more bits (e.g., B5˜B6) of first seven bits of a scrambling sequence and a second reserved bit (e.g., B7) in the SERVICE field of the control frame may be set to indicate a bandwidth for the one or more transmissions or receptions in the TXOP. Specifically, the first reserved bits may refer to B8˜B12 in the SERVICE field.

In some implementations, one or more bits (e.g., B5˜B6) of first seven bits of a scrambling sequence and the plurality of first reserved bits (e.g., B7˜B12) in the SERVICE field may be jointly set to indicate both a bandwidth and the MRU pattern for the one or more transmissions or receptions in the TXOP.

In some implementations, the plurality of bits in the User Info field of the control frame may include a PS160 subfield and a first bit (e.g., B0) of an RU Allocation subfield.

In some implementations, processor 1112 may further determine the MRU pattern according to the PS160 subfield and the first bit of the RU Allocation subfield in an event that the STA is a non-AP HE STA, a non-AP EHT STA, or a non-AP STA applied to other non-legacy protocols.

In some implementations, the first bit of the RU Allocation subfield may be set to 0 to indicate primary 20 MHz channel, primary 40 MHz channel, or primary 80 MHZ channel, or may be set to 1 to indicate primary 160 MHz channel, two 80 MHz channels, or 320 MHz channel.

In some implementations, the PS160 subfield may be set to 1 to indicate 320 MHz channel or may be set to 0 to indicate primary 20 MHz channel, primary 40 MHZ channel, primary 80 MHz channel, or primary 160 MHz channel.

In some implementations, the control frame may include an RTS, a PS-Poll, or a BAR.

In some implementations, processor 1112 may further receive or transmit, via transceiver 1116, a management frame, wherein a capability field in a MAC capability element of the management frame is set to indicate support of MU-RTS MRU puncturing.

According to some schemes of the present disclosure, processor 1112 of apparatus 1110 may detect, via transceiver 1116, preambles (e.g., from apparatus 1120) in a plurality of narrow bandwidths of a wide bandwidth. Then, processor 1112 may determine an MRU pattern regarding preamble puncturing according to the detected preambles. Also, processor 1112 may apply the MRU pattern for one or more transmissions or receptions in a TXOP.

In some implementations, each of the preambles may include an L-STF, an L-LTF, and an L-SIG field.

In some implementations, the determining of the MRU pattern may be performed by CRC checks on the L-SIG fields of the detected preambles.

In some implementations, the determining of the MRU pattern may be performed by a correlation of the L-STFs, the L-LTFs, or the L-SIG fields of the detected preambles.

According to some schemes of the present disclosure, processor 1112 of apparatus 1110 may transmit, via transceiver 1116, a first BQR (e.g., to apparatus 1120), wherein an Available Channel Bitmap subfield of the first BQR is set to indicate a first MRU pattern regarding preamble puncturing. Then, processor 1112 may perform, via transceiver 1116, a first transmission or reception according to the first MRU pattern.

In some implementations, processor 1112 may further receive or transmit, via transceiver 1116, a management frame, wherein a capability field in a MAC capability element of the management frame is set to indicate support of non-AP preamble puncturing by BQR.

In some implementations, processor 1112 may further receive, via transceiver 1116, a response of the first BQR (e.g., from apparatus 1120). Alternatively, processor 1112 may further receive, via transceiver 1116, a BQRP (e.g., from apparatus 1120), wherein the BQR is transmitted responsive to receiving the BQRP.

In some implementations, the first BQR may include CCA results sensed in a SIFS between the reception of the BQRP and the transmission of the BQR.

In some implementations, processor 1112 may further receive, via transceiver 1116, a second BQR (e.g., from apparatus 1120), wherein an Available Channel Bitmap subfield of the second BQR is set to indicate a second MRU pattern regarding preamble puncturing. Also, processor 1112 may perform, via transceiver 1116, a second transmission or reception according to either or both of the first MRU pattern and the second MRU pattern.

In some implementations, in an event that there is a conflict between the first MRU pattern and the second MRU pattern, the second transmission or reception may be performed according to only the second MRU pattern.

In some implementations, processor 1112 may further transmit, via transceiver 1116, a beacon frame (e.g., to apparatus 1120), wherein a DSCB field of the beacon frame is set to indicate a third MRU pattern regarding preamble puncturing. Specifically, in an event that there is a conflict between the third MRU pattern and the second MRU pattern, the second transmission or reception may be performed according to only the second MRU pattern.

### Illustrative Processes

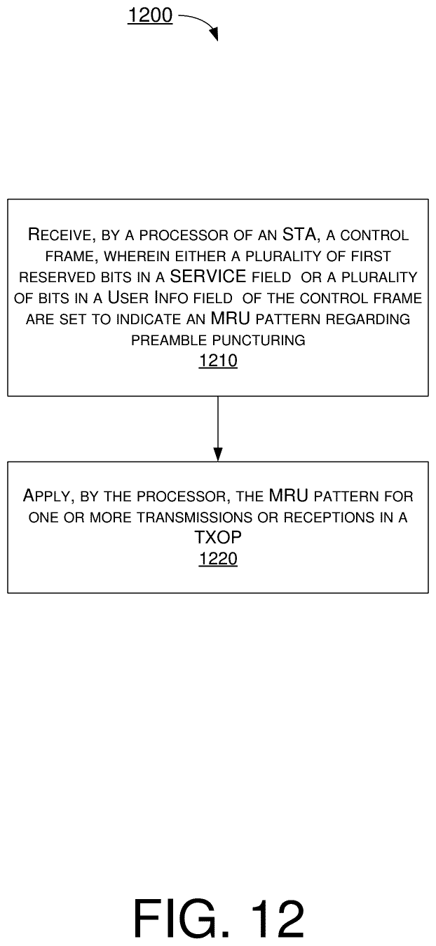

FIG. 12 illustrates an example process 1200 in accordance with an implementation of the present disclosure. Process 1200 may represent an aspect of implementing various proposed designs, concepts, schemes, systems and methods described above, whether partially or entirely, including those described above. More specifically, process 1200 may represent an aspect of the proposed concepts and schemes pertaining to preamble puncturing negotiation in wireless communications. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks/sub-blocks of process 1200 may be executed in the order shown in FIG. 12 or, alternatively in a different order. Furthermore, one or more of the blocks/sub-blocks of process 1200 may be executed iteratively. Process 1200 may be implemented by or in apparatus 1110 as well as any variations thereof. Solely for illustrative purposes and without limiting the scope, process 1200 is described below in the context of apparatus 1110 implemented in or as STA 110. Process 1200 may begin at block 1210.

At 1210, process 1200 may involve processor 1112 of apparatus 1110 receiving, via transceiver 1116, a control frame, wherein either a plurality of first reserved bits in a SERVICE field or a plurality of bits in a User Info field of the control frame are set to indicate an MRU pattern regarding preamble puncturing. Process 1200 may proceed from 1210 to 1220.

At 1220, process 1200 may involve processor 1112 applying the MRU pattern for one or more transmissions or receptions in a TXOP.

In some implementations, one or more bits (e.g., B5˜B6) of first seven bits of a scrambling sequence and a second reserved bit (e.g., B7) in the SERVICE field of the control frame may be set to indicate a bandwidth for the one or more transmissions or receptions in the TXOP. Specifically, the first reserved bits may refer to B8˜B12 in the SERVICE field.

In some implementations, one or more bits (e.g., B5˜B6) of first seven bits of a scrambling sequence and the plurality of first reserved bits (e.g., B7˜B12) in the SERVICE field may be jointly set to indicate both a bandwidth and the MRU pattern for the one or more transmissions or receptions in the TXOP.

In some implementations, the plurality of bits in the User Info field of the control frame may include a PS160 subfield and a first bit (e.g., B0) of an RU Allocation subfield.

In some implementations, process 1200 may further involve processor 1112 determining the MRU pattern according to the PS160 subfield and the first bit of the RU Allocation subfield in an event that the STA is a non-AP HE STA, a non-AP EHT STA, or a non-AP STA applied to other non-legacy protocols.

In some implementations, the first bit of the RU Allocation subfield may be set to 0 to indicate primary 20 MHz channel, primary 40 MHz channel, or primary 80 MHz channel, or may be set to 1 to indicate primary 160 MHz channel, two 80 MHz channels, or 320 MHz channel.

In some implementations, the PS160 subfield may be set to 1 to indicate 320 MHz channel or may be set to 0 to indicate primary 20 MHz channel, primary 40 MHz channel, primary 80 MHz channel, or primary 160 MHz channel.

In some implementations, the control frame may include an RTS, a PS-Poll, or a BAR.

In some implementations, process 1200 may further involve processor 1112 receiving or transmitting, via transceiver 1116, a management frame, wherein a capability field in a MAC capability element of the management frame is set to indicate support of MU-RTS MRU puncturing.

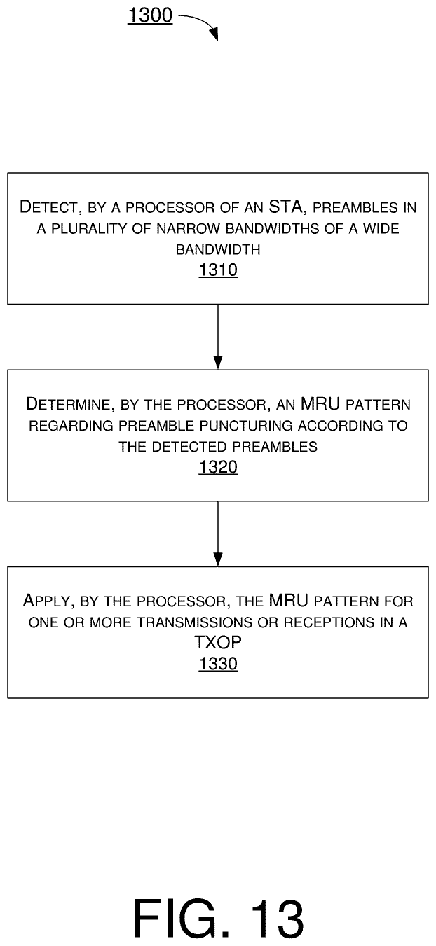

FIG. 13 illustrates an example process 1300 in accordance with an implementation of the present disclosure. Process 1300 may represent an aspect of implementing various proposed designs, concepts, schemes, systems and methods described above, whether partially or entirely, including those described above. More specifically, process 1300 may represent an aspect of the proposed concepts and schemes pertaining to preamble puncturing negotiation in wireless communications. Process 1300 may include one or more operations, actions, or functions as illustrated by one or more of blocks 1310 to 1330. Although illustrated as discrete blocks, various blocks of process 1300 may be divided into additional blocks, combined into fewer blocks, or eliminated, depending on the desired implementation. Moreover, the blocks/sub-blocks of process 1300 may be executed in the order shown in FIG. 13 or, alternatively, in a different order. Furthermore, one or more of the blocks/sub-blocks of process 1300 may be executed iteratively. Process 1300 may be implemented by or in apparatus 1110 as well as any variations thereof. Solely for illustrative purposes and without limiting the scope, process 1300 is described below in the context of apparatus 1110 implemented in or as STA 110. Process 1300 may begin at block 1310.

At 1310, process 1300 may involve processor 1112 of apparatus 1110 detecting, via transceiver 1116, preambles in a plurality of narrow bandwidths of a wide bandwidth. Process 1300 may proceed from 1310 to 1320.

At 1320, process 1300 may involve processor 1112 determining an MRU pattern regarding preamble puncturing according to the detected preambles. Process 1300 may proceed from 1320 to 1330.

At 1330, process 1300 may involve processor 1112 applying the MRU pattern for one or more transmissions or receptions in a TXOP.

In some implementations, each of the preambles may include an L-STF, an L-LTF, and an L-SIG field.

In some implementations, the determining of the MRU pattern may be performed by CRC checks on the L-SIG fields of the detected preambles.

In some implementations, the determining of the MRU pattern may be performed by a correlation of the L-STFs, the L-LTFs, or the L-SIG fields of the detected preambles.

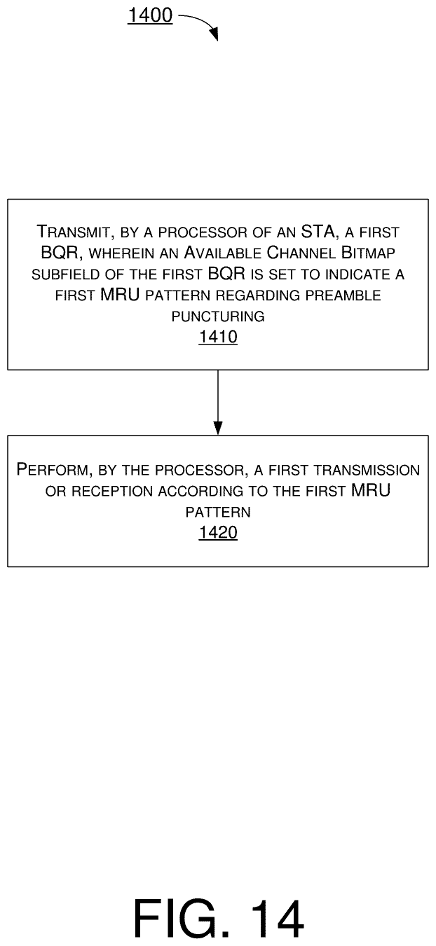

FIG. 14 illustrates an example process 1400 in accordance with an implementation of the present disclosure. Process 1400 may represent an aspect of implementing various proposed designs, concepts, schemes, systems and methods described above, whether partially or entirely, including those described above. More specifically, process 1400 may represent an aspect of the proposed concepts and schemes pertaining to preamble puncturing negotiation in wireless communications. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Moreover, the blocks/sub-blocks of process 1400 may be executed in the order shown in FIG. 14 or, alternatively, in a different order. Furthermore, one or more of the blocks/sub-blocks of process 1400 may be executed iteratively. Process 1400 may be implemented by or in apparatus 1110 as well as any variations thereof. Solely for illustrative purposes and without limiting the scope, process 1400 is described below in the context of apparatus 1110 implemented in or as STA 110. Process 1400 may begin at block 1410.

At 1410, process 1400 may involve processor 1112 of apparatus 1110 transmitting, via transceiver 1116, a first BQR, wherein an Available Channel Bitmap subfield of the first BQR is set to indicate a first MRU pattern regarding preamble puncturing. Process 1400 may proceed from 1410 to 1420.

At 1420, process 1400 may involve processor 1112 performing, via transceiver 1116, a first transmission or reception according to the first MRU pattern.

In some implementations, process 1400 may further involve processor 1112 receiving or transmitting, via transceiver 1116, a management frame, wherein a capability field in a MAC capability element of the management frame is set to indicate support of non-AP preamble puncturing by BQR.

In some implementations, process 1400 may further involve processor 1112 receiving, via transceiver 1116, a response of the first BQR (e.g., from apparatus 1120). Alternatively, process 1400 may further involve processor 1112 receiving, via transceiver 1116, a BQRP (e.g., from apparatus 1120), wherein the BQR is transmitted responsive to receiving the BQRP.

In some implementations, the first BQR may include CCA results sensed in a SIFS between the reception of the BQRP and the transmission of the BQR.

In some implementations, process 1400 may further involve processor 1112 receiving, via transceiver 1116, a second BQR (e.g., from apparatus 1120), wherein an Available Channel Bitmap subfield of the second BQR is set to indicate a second MRU pattern regarding preamble puncturing. Additionally, process 1400 may further involve processor 1112 performing, via transceiver 1116, a second transmission or reception according to either or both of the first MRU pattern and the second MRU pattern.

In some implementations, in an event that there is a conflict between the first MRU pattern and the second MRU pattern, the second transmission or reception may be performed according to only the second MRU pattern.

In some implementations, process 1400 may further involve processor 1112 transmitting, via transceiver 1116, a beacon frame (e.g., to apparatus 1120), wherein a DSCB field of the beacon frame is set to indicate a third MRU pattern regarding preamble puncturing. Specifically, in an event that there is a conflict between the third MRU pattern and the second MRU pattern, the second transmission or reception may be performed according to only the second MRU pattern.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a station (STA), a control frame, wherein either a plurality of first reserved bits in a SERVICE field or a plurality of bits in a User Info field of the control frame are set to indicate a multiple resource unit (MRU) pattern regarding preamble puncturing; and
applying, by the processor, the MRU pattern for one or more transmissions or receptions in a transmission opportunity (TXOP).

2. The method of claim 1, wherein one or more bits of first seven bits of a scrambling sequence and a second reserved bit in the SERVICE field of the control frame are set to indicate a bandwidth for the one or more transmissions or receptions in the TXOP.

3. The method of claim 1, wherein one or more bits of first seven bits of a scrambling sequence and the plurality of first reserved bits in the SERVICE field are jointly set to indicate both a bandwidth and the MRU pattern for the one or more transmissions or receptions in the TXOP.

4. The method of claim 1, wherein the plurality of bits in the User Info field of the control frame comprises a PS160 subfield and a first bit of a resource unit (RU) Allocation subfield.

5. The method of claim 4, further comprising:
determining, by the processor, the MRU pattern according to the PS160 subfield and the first bit of the RU Allocation subfield in an event that the STA is a non-access point (non-AP) high-efficiency (HE) STA, a non-AP extremely-high-throughput (EHT) STA, or a non-AP STA applied to other non-legacy protocols.

6. The method of claim 5, wherein the first bit of the RU Allocation subfield is set to 0 to indicate primary 20 mega-hertz (MHz) channel, primary 40 MHz channel, or primary 80 MHz channel, or is set to 1 to indicate primary 160 MHz channel, two 80 MHz channels, or 320 MHz channel.

7. The method of claim 5, wherein the PS160 subfield is set to 1 to indicate 320 mega-hertz (MHz) channel, or is set to 0 to indicate primary 20 MHz channel, primary 40 MHz channel, primary 80 MHz channel, or primary 160 MHz channel.

8. The method of claim 1, wherein the control frame comprises a request-to-send (RTS), a power save poll (PS-Poll), or a block acknowledgement request (BAR).

9. The method of claim 1, further comprising:
receiving or transmitting, by the processor, a management frame, wherein a capability field in a Medium Access Control (MAC) capability element of the management frame is set to indicate support of multiple user-request-to-send (MU-RTS) MRU puncturing.

10. A method, comprising:
detecting, by a processor of a station (STA), preambles in a plurality of narrow bandwidths of a wide bandwidth;
determining, by the processor, a multiple resource unit (MRU) pattern regarding preamble puncturing according to the detected preambles; and
applying, by the processor, the MRU pattern for one or more transmissions or receptions in a transmission opportunity (TXOP).

11. The method of claim 10, wherein each of the preambles comprises a legacy short training field (L-STF), a legacy long training field (L-LTF), and a legacy signal (L-SIG) field.

12. The method of claim 11, wherein the determining of the MRU pattern is performed by cyclic redundancy check (CRC) checks on the L-SIG fields of the detected preambles.

13. The method of claim 11, wherein the determining of the MRU pattern is performed by a correlation of the L-STFs, the L-LTFs, or the L-SIG fields of the detected preambles.

14. A method, comprising:
transmitting, by a processor of a first station (STA), a first bandwidth query report (BQR), wherein an Available Channel Bitmap subfield of the first BQR is set to indicate a first multiple resource unit (MRU) pattern regarding preamble puncturing; and
performing, by the processor, a first transmission or reception according to the first MRU pattern.

15. The method of claim 14, further comprising:
receiving or transmitting, by the processor, a management frame, wherein a capability field in a Medium Access Control (MAC) capability element of the management frame is set to indicate support of non-AP preamble puncturing by BQR.

16. The method of claim 14, further comprising:
receiving, by the processor, a response of the first BQR; or
receiving, by the processor, a bandwidth query report poll (BQRP), wherein the BQR is transmitted responsive to receiving the BQRP.

17. The method of claim 16, wherein the first BQR comprises clear channel assessment (CCA) results sensed in a short interframe space (SIFS) between the reception of the BQRP and the transmission of the BQR.

18. The method of claim 14, further comprising:
receiving, by the processor, a second BQR, wherein an Available Channel Bitmap subfield of the second BQR is set to indicate a second MRU pattern regarding preamble puncturing; and
performing, by the processor, a second transmission or reception according to either or both of the first MRU pattern and the second MRU pattern.

19. The method of claim 18, wherein, in an event that there is a conflict between the first MRU pattern and the second MRU pattern, the second transmission or reception is performed according to only the second MRU pattern.

20. The method of claim 18, further comprising:
transmitting, by the processor, a beacon frame, wherein a disabled sub-channel bitmap (DSCB) field of the beacon frame is set to indicate a third MRU pattern regarding preamble puncturing;
wherein, in an event that there is a conflict between the third MRU pattern and the second MRU pattern, the second transmission or reception is performed according to only the second MRU pattern.
